(19) United States
(12) Patent Application Publication
(10) Pub. No.: US 2018/0319355 A1
(43) Pub. Date: Nov. 8, 2018

(54) WIRE CONTAINING SLEEVE FOR VEHICLE AND METHOD FOR MANUFACTURING WIRE CONTAINING SLEEVE FOR VEHICLE

(71) Applicants: MAEDA KOSEN CO., LTD., Sakai-shi, Fukui (JP); AUTONETWORKS TECHNOLOGIES, LTD., Yokkaichi-shi, Mie (JP); SUMITOMO WIRING SYSTEMS, LTD., Yokkaichi-shi, Mie (JP); SUMITOMO ELECTRIC INDUSTRIES, LTD., Osaka-shi, Osaka (JP)

(72) Inventors: Yoshitsugu SUSAKI, Sakai-shi, Fukui (JP); Hiroki ICHIURA, Sakai-shi, Fukui (JP); Akihiro NISHIO, Sakai-shi, Fukui (JP); Yasuyuki YAMAMOTO, Yokkaichi-shi, Mie (JP); Housei MIZUNO, Yokkaichi-shi, Mie (JP)

(21) Appl. No.: 15/774,905

(22) PCT Filed: Aug. 9, 2016
(86) PCT No.: PCT/JP2016/003672

§ 371 Date: May 9, 2018

(30) Foreign Application Priority Data
Nov. 24, 2015 (JP) 2015-228890

(51) Int. Cl. B60R 16/02; D04H 3/16; H02G 3/04

(52) U.S. Cl. CPC B60R 16/0215; H02G 3/04; D04H 3/16

(57) ABSTRACT

[Problem] To provide a wire containing sleeve for vehicle which is good in workability, can sufficiently suppress slapping sound from being generated, and is also good in abrasion resistance and a method for manufacturing the wire containing sleeve for vehicle.

[Solving Means] The present invention is a wire containing sleeve for vehicle (1) made of filament nonwoven fabric having a surface in which concave parts (3) are formed and, more preferably, the wire containing sleeve for vehicle (1) which has a C-shaped section, has facing ends (5) having a minimum distance therebetween is 1 mm or more, and has the concave parts (3) formed in an outside surface (1a).

### TECHNICAL FIELD

The present invention relates to a wire containing sleeve for vehicle and a method for manufacturing a wire containing sleeve for vehicle and, more specifically, to a wire containing sleeve for vehicle and a method for manufacturing a wire containing sleeve for vehicle to protect a metal wire, a cable, or the like.

### BACKGROUND ART

In the field of automobile engineering or other fields, an electric wire (to be referred to as a wire rod hereinafter) such as a metal wire or a cable is coated with a cylindrical wire containing sleeve to protect the wire rod from damage caused by external impact.

As the wire containing sleeve, a sleeve made of a metal, a resin, or rubber is generally used. However, these wire containing sleeves disadvantageously generate relatively loud slapping sound. The slapping sound means sound generated by friction between wire containing sleeves containing wires therein or friction between a wire containing sleeve containing a wire therein and a vehicle structural object.

In addition, since these wire containing sleeves have poor flexibility, the wire rods cannot be disadvantageously installed in curved parts.

In contrast to this, a wire containing sleeve made of fiber having good flexibility has been developed.

For example, a tube-like sleeve obtained by weaving and knitting or texturing a monofilament yarn made of polyester, nylon, polypropylene, or acrylic and a tape-like nonwoven base material with each other is known (for example, see Patent Literature 1).

Furthermore, an auto-wrapping sleeve which has an nonwoven long polyester wall having facing sides extending along a longitudinal axis of the sleeve and automatically wraps a circumference along the longitudinal axis to regulate a tube-like cavity, can elongate to separate the sides from each other by external force, the wall being needle-felted in at least a part of the thickness of the wall, having partially tangled polyester fiber, and being compressed to increase the density of the wall is known (for example, see Patent Literature 2).

### CITATION LIST

### Patent Literature

PTL 1: Japanese Patent Application Laid-Open No. 4247525

PTL 2: Japanese Patent Application Laid-Open No. 5261739

### SUMMARY OF INVENTION

### Technical Problem

However, in a sleeve described in the Patent Literature 1, when a wire rod is to be inserted into the sleeve, the wire rod must be inserted from an opening at one end of the sleeve with poor workability.

On the other hand, in a sleeve described in the Patent Literature 2, since facing sides extending along the longitudinal axis of the sleeve must be separated from each other to insert a wire rod into the sleeve, good workability cannot be truly achieved.

Since the sleeve described in the Patent Literature 1 has many gaps between respective fibers, slapping sound cannot be suppressed from being generated, and sufficient abrasion resistance cannot be also achieved.

On the other hand, since the sleeve described in the Patent Literature 2 is made of needle felt having a low degree of interweaving, slapping sound cannot be suppressed from being generated, and sufficient abrasion resistance cannot be also achieved.

In a vehicle or the like, since a wire rod frequently moves in conjunction with a specific device, slapping sound is easily generated, and a sleeve is easily worn.

The present invention has been made in consideration of the above circumstances, and has as its object to provide a wire containing sleeve for vehicle which is good workability, can sufficiently suppress slapping sound from being generated, and is also good abrasion resistance and a method for manufacturing the wire containing sleeve for vehicle.

### Solution to Problems

When the present inventors devoted themselves to examination to solve the problems described above, the present inventors found to able to solve the above problems by making the sleeve of nonwoven fabric having a surface in which concave parts are formed and made of filaments having C-shaped sections and setting distances between ends within a predetermined range so as to complete the present invention.

The present invention is in (1) a wire containing sleeve for vehicle made of filament nonwoven fabric having in which a plurality of concave parts are formed.

The present invention is in (2) the wire containing sleeve for vehicle described in the (1) and having a C-shaped section.

The present invention is in (3) the wire containing sleeve for vehicle described in the (2) in which a minimum distance between facing ends is 1 mm or more.

The present invention is in (4) the wire containing sleeve for vehicle described in any one of the (1) to (3) in which concave parts are formed in an outside surface.

The present invention is in (5) the wire containing sleeve for vehicle described in the (4) in which the concave ports are formed by welding.

The present invention is in (6) the wire containing sleeve for vehicle described in any one of the (1) to (5) in which a ratio of the occupied area of the concave parts to a unit area on the surface is 15% to 16% and a ratio of the depth of the concave parts to the thickness of the filament nonwoven fabric is 50% to 80%.

The present invention is in (7) the wire containing sleeve for vehicle described in any one of the (1) to (6) in which the filament nonwoven fabric is spunbond nonwoven fabric.

The present invention is in (8) the wire containing sleeve for vehicle described in any one of the (1) to (7) in which the shape of each of the concave parts are a rectangular shape when viewed from the top and a minimum distance between adjacent concave parts falls within a range of 1 mm to 5 mm.

The present invention is in (9) the wire containing sleeve for vehicle described in any one of the (1) to (8) and is used to contain a wire rod.

The present invention is in (10) a method for using the wire containing sleeve for vehicle described in any one of the (1) to (9) in which the wire containing sleeve for vehicle contains a wire rod, the circumferential length of the wire containing sleeve for vehicle is set to be 1.2 to 2 times the circumference of the wire rod, and the outer periphery of the wire containing sleeve for vehicle is fixed with a tape in a state in which the wire containing sleeve for vehicle is wrapped on the outer periphery of the wire rod to partially overlap.

The present invention is in (11) a method for manufacturing the wire containing sleeve for vehicle described in any one of the (1) to (9) and including a welding step of performing a welding process to an aggregate of cotton-like filaments to form filament nonwoven fabric, a heating step of heating the filament nonwoven fabric, a forming step of causing the heated filament nonwoven fabric to pass through a columnar mold to form a wire containing sleeve for vehicle having a C-shaped section, and a cooling step of cooling the wire containing sleeve for vehicle.

The present invention is in (12) the method for manufacturing a wire containing sleeve for vehicle described in the (11) in which, in the welding step, the moment the welding process is performed to an aggregate of cotton-like filaments to form a filament nonwoven fabric, concave parts are formed in the surface of the filament fabric.

### Advantageous Effects of Invention

In the wire containing sleeve for vehicle according to the present invention, the concave parts are formed in the surface to make it possible to sufficiently suppress slapping sound from being generated. At this time, a ratio of the occupied area of the concave parts to a unit area on the surface preferably falls within the range of 15% to 60% and a ratio of the depth of the concave parts to the thickness of the filament nonwoven fabric preferably falls within the range of 50% to 80%. When the concave parts are formed in an outside surface, slapping sound is more greatly suppressed from being generated.

In the wire containing sleeves for vehicle according to the present invention, when the concave parts formed outside are formed by welding, abrasion of the wire containing sleeves for vehicle themselves caused by rubbing between the wire containing sleeves for vehicle or the wire containing sleeves for vehicle and a vehicle structural object.

The wire containing sleeve for vehicle according to the present invention is good in flexibility because the wire containing sleeve for vehicle is made of fabric. In this manner, even though a wire rod is installed in a curved part, the wire containing sleeve for vehicle can be used as a wire containing sleeve for vehicle to protect the wire rod.

As the fabric, filament nonwoven fabric is used to make it possible to improve abrasion resistance. When the filament nonwoven fabric is spunbond nonwoven fabric, the abrasion resistance is more greatly improved.

Furthermore, the section of the wire containing sleeve for vehicle is made C-shaped to cause a distance between ends of the fabric to fall within a predetermined range, so that a wire rod can be easily inserted into the wire containing sleeve for vehicle from between the ends. For this reason, the workability is improved.

In the wire containing sleeve for vehicle according to the present invention, when the shape of each of the concave parts are rectangular shapes when viewed from the top, slapping sound can be more greatly suppressed from being generated when the minimum distance between adjacent concave parts falls within the range of 1 mm to 5 mm.

The wire containing sleeve for vehicle according to the present invention can be preferably used to contain a wire rod such as a metal wire or cable.

In the method for using a wire containing sleeve for vehicle according to the present invention, since the wire containing sleeve for vehicle described above is used, good workability can be achieved when a wire rod is inserted into the wire containing sleeve for vehicle.

A wire rod is contained in the wire containing sleeve for vehicle, the length of the wire containing sleeve for vehicle in the circumferential direction is set to be 1.2 to 2 times the circumference of the wire rod, the outer periphery is fixed with a tape in a state in which the wire containing sleeve for vehicle is wrapped on the outer periphery of the wire rod to partially overlap. For this reason, even though the wire rod is installed in a curved part, the wire rod can be prevented from being exposed.

In the method for manufacturing a wire containing sleeve for vehicle according to the present invention, the welding step, the heating step, the forming step, and the cooling step are performed to make it possible to easily manufacture the wire containing sleeve for vehicle described above.

In the welding step, the moment a welding process is performed to an aggregate of cotton-like filaments to form filament nonwoven fabric, concave parts are formed in the surface of the filament nonwoven fabric to make it possible to efficiently manufacture a wire containing sleeve for vehicle having the concave parts.

### BRIEF DESCRIPTION OF DRAWINGS

FIG. 1 is a perspective view typically showing an embodiment of a wire containing sleeve for vehicle according to the present invention.

FIG. 2 is a sectional view typically showing the wire containing sleeve for vehicle according to the embodiment.

FIG. 3 is a front view showing an enlarged part of an outside surface of the wire containing sleeve for vehicle according to the embodiment.

FIGS. 4A to 4C are explanatory diagrams for explaining a method for using the wire containing sleeve for vehicle according to the embodiment.

FIG. 5 is a flow chart showing a method for manufacturing a wire containing sleeve for vehicle according to the present invention.

FIG. 6A is an explanatory diagram for explaining a welding step in the method for manufacturing a wire containing sleeve for vehicle according to the embodiment, and FIG. 6B is a perspective view showing a welding press used in the welding step.

FIG. 7 is an explanatory diagram for explaining a cutting step in the method for manufacturing a wire containing sleeve for vehicle according to the embodiment.

FIG. 8A is an explanatory diagram for explaining a heating step, a forming step, and a cooling step in the method for manufacturing a wire containing sleeve for vehicle according to the embodiment, and FIG. 8B is a sectional view showing a columnar mold used in the forming step.

FIG. 9 is a perspective view typically showing a filament used in a wire containing sleeve for vehicle according to another embodiment.

### DESCRIPTION OF EMBODIMENTS

Preferable embodiments of the present invention will be described below in detail with reference to the accompanying drawing as needed. The same reference numerals or symbols denote the same parts in the drawings, and overlapping descriptions will be omitted. Positional relationships such as vertical and horizontal positional relationships are based on positional relationships shown in the drawings unless otherwise noted. Furthermore, the dimensional ratios in the drawings are not limited to illustrated ratios.

The wire containing sleeve for vehicle according to the present invention is used in a vehicle and contains a wire rod such as a metal wire or cable to protect the metal wire from damage caused by external impact.

The vehicles include an automobile, a railway car, a military vehicle, a motorized bicycle, a non-motorized vehicle, a trolleybus, and the like.

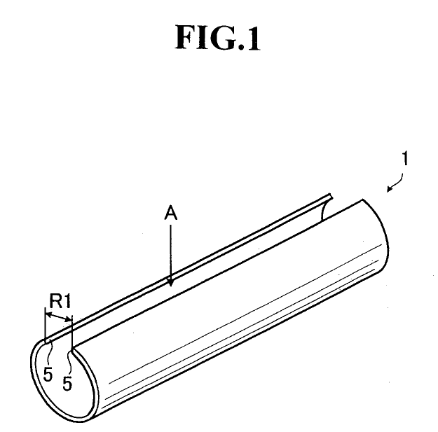

FIG. 1 is a perspective view typically showing an embodiment of the wire containing sleeve for vehicle according to the present invention. In FIG. 1, concave parts are not shown.

As shown in FIG. 1, a wire containing sleeve for vehicle 1 according to the embodiment is cylindrical and has a shape kept in a state in which a gap is formed in the wire containing sleeve for vehicle along the longitudinal direction thereof.

More specifically, the wire containing sleeve for vehicle 1 has a C-shaped section, and a gap is formed between ends 5. The wire containing sleeve for vehicle 1 having the C-shaped section includes not only a wire containing sleeve for vehicle having a C-shaped section but also U-shaped and V-shaped wire containing sleeves for vehicle.

In the wire containing sleeve for vehicle 1, the length in the longitudinal direction is preferably 50 mm or more. In this manner, working efficiency when a wire rod is inserted into the wire containing sleeve for vehicle 1 is improved.

Furthermore, in the wire containing sleeve for vehicle 1, a minimum distance R1 between the facing ends 5 is 1 mm or more in terms of workability, preferably falls within the range of 1 mm to 50 mm, more preferably falls within the range of 2 mm to 30 mm, and still more preferably falls within the range of 6 mm to 20 mm.

As described above, in the wire containing sleeve for vehicle 1, the predetermined distance R1 is set between the ends 5 to make it possible to insert from between the ends 5 into the wire containing sleeve for vehicle 1 sideways in the direction of an arrow A. As a result, the workability is extremely improved.

The wire containing sleeve for vehicle 1 is made of nonwoven fabric manufactured by filaments. In this specification, nonwoven fabric manufactured by filaments is called filament nonwoven fabric.

As described above, the wire containing sleeve for vehicle 1 is good in flexibility because the wire containing sleeve for vehicle 1 is made of fabric. In this manner, even though a wire rod should be installed in a curved part, a wire containing sleeve for vehicle protecting the wire rod can be used while being curved.

The wire containing sleeve for vehicle is made of fabric, especially filament nonwoven fabric to make it possible to improve abrasion resistance.

In this case, the filament means a fiber having a filament length of 100 mm or more.

The filament may be a monofilament or a multifilament.

As the material of the filament, polyethylene, polyolefin such as polypropylene, polyester, polyamide such as nylon, and the like are given.

Furthermore, as the nonwoven fabric, spunbond fabric, nonwoven fabric such as meltblown nonwoven fabric made by fleece forming method, and nonwoven fabric such as thermal bond nonwoven fabric made by a fleece bonding method are given. Of the nonwoven fabrics, as the nonwoven fabric, spunbond nonwoven fabric is preferably used.

In the wire containing sleeve for vehicle 1, a thickness T of the entire filament nonwoven fabric preferably falls within the range of 0.5 mm to 4 mm. When the thickness T is smaller than 0.5 mm, in comparison with the case in which the thickness T falls within the range, a so-called tensile strength becomes low. For this reason, the wire containing sleeve for vehicle may be broken in a process executed after a wire rod is inserted into the wire containing sleeve for vehicle, and slapping sound easily occurs. When the thickness T exceeds 4 mm, in comparison with the case in which the thickness T falls within the range, flexibility is deteriorated. For this reason, the wire containing sleeve for vehicle is difficult to be handled when the wire containing sleeve for vehicle is installed in a curved part.

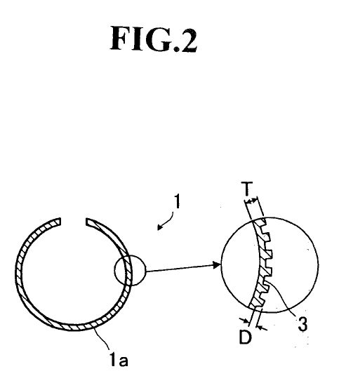

FIG. 2 is a sectional view typically showing the wire containing sleeve for vehicle according to the embodiment.

As shown in FIG. 2, in the wire containing sleeve for vehicle 1, a plurality of concave parts 3 are formed over an entire outside surface 1a. In this manner, even though the wire containing sleeves for vehicle 1 are rubbed with each other or the wire containing sleeve for vehicle 1 and a vehicle structural object are rubbed with each other, since the concave parts 3 are formed in the outside surface 1a of the wire containing sleeve for vehicle 1, a sound absorption effect of the concave parts 3 and cushioning properties of convex parts between the concave parts 3 can suppress slapping sound from being generated.

In this case, the concave parts 3 are formed such that one surface of filament nonwoven fabric is heated and fibers on the peripheries of the concave parts 3 are melted to weld the fibers with each other. As a method for forming the concave parts 3, as will be described later, when filament nonwoven fabric is manufactured by an aggregate of cotton-like filaments, the concave parts 3 may be formed. After the filament nonwoven fabric is manufactured, the concave parts 3 may be formed by an emboss process (uneven process performed by emboss pattern fusing), an ultrasonic sealer, or the like.

In this case, since the side surfaces and the bottom surface of each of at least the concave parts 3 are partially resinified, abrasion resistance is more greatly improved.

Thus, when the wire containing sleeve for vehicle 1 has an outside surface having concave parts 3 and partially welded, even though the wire containing sleeves for vehicle 1 are rubbed or the wire containing sleeve for vehicle 1 and a vehicle structural object are rubbed, sufficient abrasion resistance can be exerted.

At this time, a depth D of the concave parts 3 preferably falls within the range of 50% to 80% to the thickness T of the filament nonwoven fabric, and, more preferably, 60% to 70%.

When the depth D of the concave parts 3 is smaller than 50% to the thickness T of the filament nonwoven fabric, in comparison with a case in which the depth D of the concave parts 3 falls within the range to the thickness T of the filament nonwoven fabric, the fiber density of the concave parts 3 decreases. For this reason, sufficient abrasion resistance may not be able to be exerted. When the depth D of the concave parts 3 exceeds 80% to the thickness T of the filament nonwoven fabric, in comparison with the case in which the depth D of the concave parts 3 falls within the range to the thickness T of the filament nonwoven fabric, the durability of the concave parts 3 is disadvantageously insufficient.

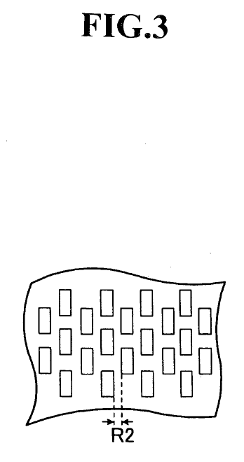

FIG. 3 is a front view showing an enlarged part of an outside surface of the wire containing sleeve for vehicle according to the embodiment.

As shown in FIG. 3, the shape of each of the concave parts 3 is a rectangular shape when viewed from the top, and the concave parts 3 are arranged at intervals in every direction in the form of a houndstooth check.

In this case, a ratio of the occupied area of the concave parts 3 to a unit area of the outside surface of the wire containing sleeve for vehicle 1 preferably falls within the range of 15% to 60%, and, more preferably, 15% to 40%.

Furthermore, a minimum distance R2 between the adjacent concave parts 3 preferably falls within 1 mm to 5 mm, and, more preferably, 2 mm to 3 mm.

When these conditions are satisfied, sound absorbing effect and abrasion resistance can be sufficiently exerted by the concave parts 3.

A method for using the wire containing sleeve for vehicle 1 will be described below.

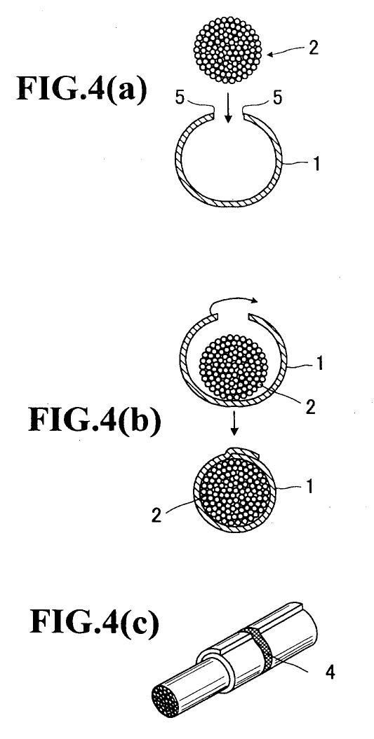

FIGS. 4A to 4C are explanatory diagrams for explaining a method for using a wire containing sleeve for vehicle according to the embodiment. FIGS. 4A and 4B are sectional views typically showing the wire containing sleeve for vehicle and a wire rod, and FIG. 4C is a perspective view showing a state in which the wire containing sleeve for vehicle is cut to partially expose the wire rod.

As shown in FIG. 4A, a wire rod 2 is inserted from the gap between the ends 5 of the wire containing sleeve for vehicle 1. The wire rod 2 may be made from one metal wire or cable or may be a bundle of metal wires or cables.

As shown in FIG. 4B, the ends 5 of the wire containing sleeve for vehicle 1 are overlapped while the wire rod 2 is contained.

At this time, the length of the wire containing sleeve for vehicle 1 in the circumferential direction is preferably 1.2 times to 2.0 times of the circumference of the wire rod 2. In this manner, the wire containing sleeve for vehicle 1 can be wrapped on the outer periphery of the wire rod 2 such that the wire containing sleeve for vehicle 1 partially overlaps. As a result, even though the wire rod 2 is installed in a curved part, the wire rod 2 can be prevented from being exposed.

Finally, when the outer periphery of the wire containing sleeve for vehicle 1 is fixed with a tape 4, as shown in FIG. 4C, the wire rod is held in a state in which the wire containing sleeve for vehicle 1 is wrapped on the outer periphery of the wire rod.

As the tape 4, a known tape is arbitrarily employed, and the material of the tape 4 is not limited to a specific material.

As described above, in the method for using the wire containing sleeve for vehicle 1, since a space is made between the ends 5, the wire rod 2 can be inserted from above the wire containing sleeve for vehicle 1.

In addition, the wire rod 2 is contained, the length of the wire containing sleeve for vehicle 1 in the circumferential direction is made 1.2 times to 2 times the circumference of the wire rod, and the outer periphery of the wire containing sleeve for vehicle 1 is fixed with the tape 4 in a state in which the wire containing sleeve for vehicle 1 is wrapped on the outer periphery of the wire rod 2 to partially overlap. In this manner, even though the wire rod 2 is installed in a curved part, the wire rod 2 can be reliably prevented from being exposed.

A method for manufacturing a wire containing sleeve for vehicle according to the present invention will be described below.

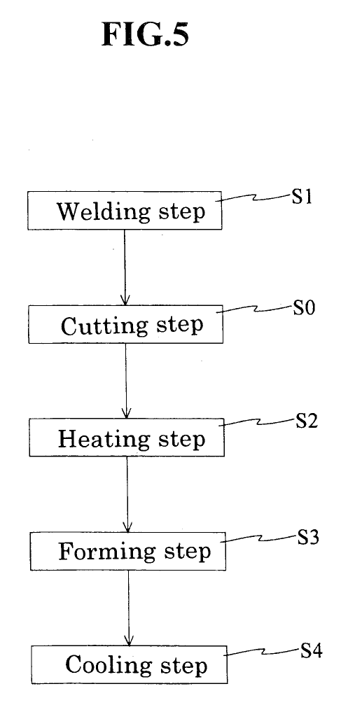

FIG. 5 is a flow chart showing an embodiment of the method for manufacturing a wire containing sleeve for vehicle according to the present invention.

As shown in FIG. 5, the method for manufacturing a wire containing sleeve for vehicle according to the embodiment includes a welding step S1, a cutting step S0, a heating step S2, a forming step S3, and a cooling step S4.

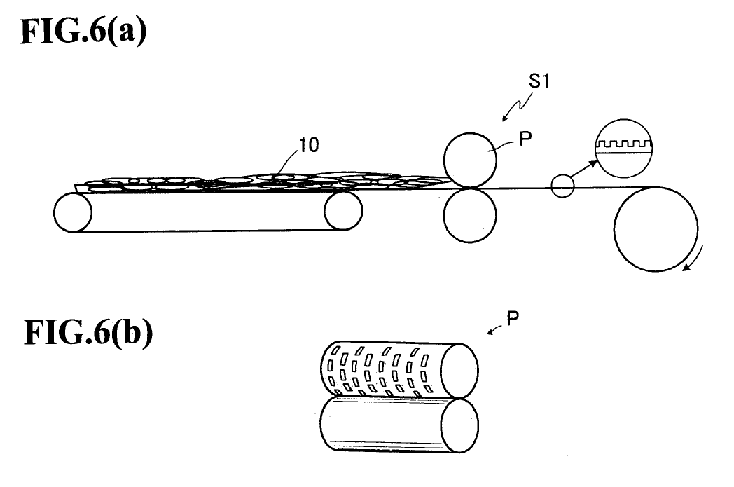

FIG. 6A is an explanatory diagram for explaining the welding step in the method for manufacturing a wire containing sleeve for vehicle according to the embodiment, and FIG. 6B is a perspective view showing a welding press used in the welding step.

As shown in FIG. 6A, in the welding step S1, an aggregate 10 of cotton-like filaments is pressed with welding rolls P to which an uneven pattern is applied to apply a welding process to the aggregate 10 so as to obtain filament nonwoven fabric.

At this time, when the uneven pattern is applied to one of the welding rolls (see FIG. 6B), the moment filament nonwoven fabric is manufactured by the aggregate 10 of filaments, the concave parts 3 are formed in the surface of the filament nonwoven fabric. At this time, the concave parts 3 are welded while a fiber density is kept high, and the other parts are welded while a fiber density is low.

The filament nonwoven fabric in which the concave parts 3 are formed is temporarily winded.

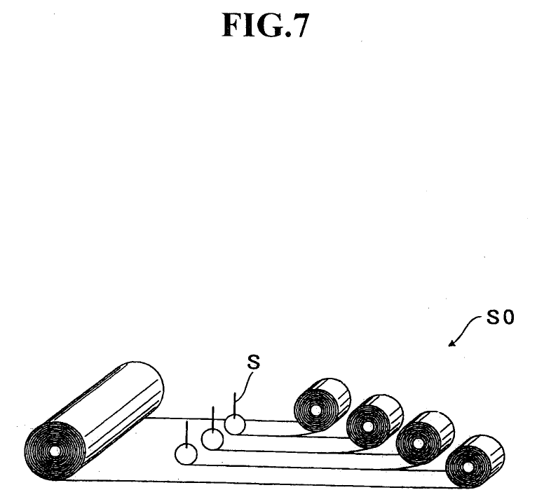

FIG. 7 is an explanatory diagram for explaining the cutting step in the method for manufacturing a wire containing sleeve for vehicle according to the embodiment.

As shown in FIG. 7, in the cutting step S0, the filament nonwoven fabric obtained in the welding step S1 is cut in the forms of ribbons in the longitudinal direction by using a slit device S.

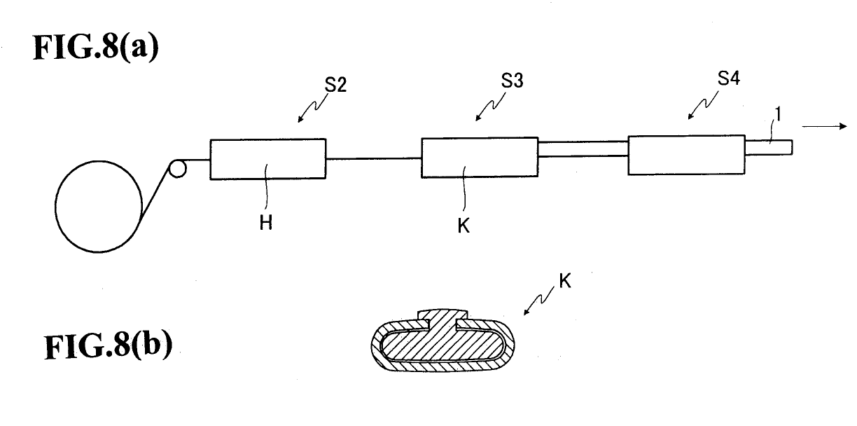

FIG. 8A is an explanatory diagram for explaining the heating step, the forming step, and the cooling step in the method for manufacturing a wire containing sleeve for vehicle according to the embodiment, and FIG. 8B is a sectional view showing a columnar mold used in the forming step.

As shown in FIG. 8A, in the heating step S2, the filament nonwoven fabric is heated by a heater H to soften the filament nonwoven fabric.

In the forming step S3, the heated filament nonwoven fabric is inserted into a columnar mold K (FIG. 8B) to obtain a C-shaped section.

At this time, the minimum distance between the facing ends 5 is adjusted to 1 mm or more.

In the cooling step S4, the wire containing sleeve for vehicle 1 is quickly cooled. In this manner, the wire containing sleeve for vehicle 1 (see FIG. 1) which is cylindrical and has the shape having a gap formed along the longitudinal direction.

In the method for manufacturing a wire containing sleeve for vehicle according to the embodiment, the steps are performed to make it possible to easily manufacture the wire containing sleeve for vehicle 1.

In addition, in the welding step S1, the moment the welding process is performed to an aggregate of cotton-like filaments to form filament nonwoven fabric, concave parts are formed in the surface of the filament nonwoven fabric to make it possible to efficiently manufacture a wire containing sleeve for vehicle having the concave parts.

Although the preferable embodiment of the present invention has been described above, the present invention is not limited to the embodiment.

For example, in the wire containing sleeve for vehicle 1 according to the embodiment, monofilaments or multifilaments are used as filaments, filaments each having a core-in-sheath structure may be used, or filaments each having a side-by-side two-component structure may be used.

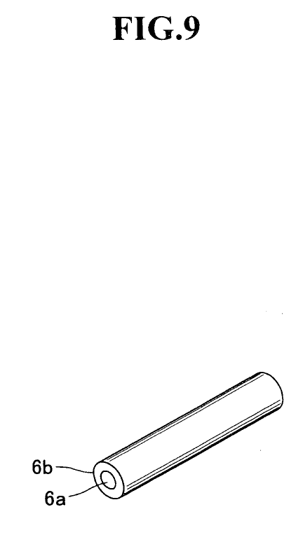

FIG. 9 is a perspective view typically showing a filament used in a wire containing sleeve for vehicle according to another embodiment.

As shown in FIG. 9, in the wire containing sleeve for vehicle according to the other embodiment, the filament has a core-in-sheath structure including a core part 6a and a sheath part 6b. More specifically, the wire containing sleeve for vehicle is made of filament nonwoven fabric using filaments each having a core-in-sheath structure.

At this time, a thermoplastic resin constituting the core part 6a preferably has a melting point 30° C. or more higher than the melting point of a thermoplastic resin constituting the sheath part 6b. In this case, filament nonwoven fabric using the filaments is improved in strength and heat resistance on the basis of the core parts 6a of the filaments, and the sheath parts of adjacent filaments are welded to each other to improve abrasion resistance.

In the wire containing sleeve for vehicle 1 according to the embodiment, the plurality of concave parts 3 are formed over the entire outside surface 1a. However, the plurality of concave parts 3 may be formed in the inside surface or may be formed in both the surfaces.

In the wire containing sleeve for vehicle 1 according to the embodiment, the shape of each of the concave parts 3 is rectangular when viewed from the top. However, the shape is not limited to the rectangular shape, and the wire containing sleeve for vehicle 1 may have a circular shape, a lozenged shape, or the like when viewed from the top.

Although the concave parts 3 are regularly arranged in all directions, the concave parts 3 may be irregularly arranged.

### INDUSTRIAL APPLICABILITY

The wire containing sleeve for vehicle according to the embodiment, the method for using a wire containing sleeve for vehicle according to the embodiment, and the method for manufacturing a wire containing sleeve for vehicle according to the embodiment are used to, in the fields of automobile engineering or other mechanical engineering, cover an electric wire (wire rod) such as a metal wire or cable to protect the electric wire from damage caused by external impact.

According to the wire containing sleeve for vehicle of the present invention is good in workability, can sufficiently suppress slapping sound from being generated, and is also good in abrasion resistance.

### REFERENCE SIGNS LIST

1 . . . wire containing sleeve for vehicle

1a . . . outside surface

10 . . . aggregate of filaments

2 . . . wire rod

3 . . . concave part

4 . . . tape

5 . . . end

D . . . depth

H . . . heater

K . . . mold

P . . . welding press

R, R2 . . . distance

S1 . . . welding step

S2 . . . heating step

S3 . . . forming step

S4 . . . cooling step

T . . . thickness

1. A wire containing sleeve for vehicle made of filament nonwoven fabric having a surface in which a plurality of concave parts are formed.

2. The wire containing sleeve for vehicle according to claim 1, wherein a section is C-shaped.

3. The wire containing sleeve for vehicle according to claim 2, wherein a minimum distance between facing ends is 1 mm or more.

4. The wire containing sleeve for vehicle according to claim 1, wherein the concave parts are formed in an outside surface.

5. The wire containing sleeve for vehicle according to claim 4, wherein the concave parts are formed by welding.

6. The wire containing sleeve for vehicle according to claim 1, wherein
a ratio of an occupied area of the concave parts to a unit area on the surface falls within the range of 15% to 60%, and
a radio of a depth of the concave parts to a thickness of the filament nonwoven fabric falls within the range of 50% to 80%.

7. The wire containing sleeve for vehicle according to claim 1, wherein
the filament nonwoven fabric is a spunbond nonwoven fabric.

8. The wire containing sleeve for vehicle according to claim 1, wherein
the shape of each of the concave parts is rectangular when viewed from the top, and
the minimum distance between concave parts adjacent to each other falls within the range of 1 mm to 5 mm.

9. The wire containing sleeve for vehicle according to claim 1, wherein
the wire containing sleeve for vehicle is used to contain a wire rod.

10. A method for using the wire containing sleeve for vehicle according to claim 1,, wherein
the wire containing sleeve for vehicle contains a wire rod,
a length of the wire containing sleeve for vehicle in a circumferential direction is set to be 1.2 to 2 times a circumference of the wire rod, and
an outer periphery of the wire containing sleeve for vehicle is fixed with a tape in a state in which the wire containing sleeve for vehicle is wrapped on an outer periphery of the wire rod to partially overlap.

11. A method for manufacturing a wire containing sleeve for vehicle according to claim 1, comprising:
the welding step performing a welding process to an aggregate of cotton-like filaments to form filament nonwoven fabric;
the heating step of heating the filament nonwoven fabric;
the forming step of inserting the heated filament nonwoven fabric into a columnar mold to form a wire containing sleeve for vehicle having a C-shaped section; and
the cooling step of cooling the wire containing sleeve for vehicle.

12. The method for manufacturing a wire containing sleeve for vehicle according to claim 11, wherein
in the welding step, the moment a welding process is performed to the aggregate of cotton-like filaments to form filament nonwoven fabric, concave parts are formed in a surface of the filament nonwoven fabric.
